(19) United States
(12) Patent Application Publication
(10) Pub. No.: US 2011/0068110 A1
(43) Pub. Date: Mar. 24, 2011

(54) BAKING PAN ASSEMBLY

(76) Inventors: Scott R. Weld, Plymouth, MN (US); Scott J. McClean, Pacific Palasades, CA (US)

(21) Appl. No.: 12/956,907

(22) Filed: Nov. 30, 2010

Related U.S. Application Data
(62) Division of application No. 10/855,069, filed on May 27, 2004, now abandoned.

(51) Int. Cl. A47J 37/01

(52) U.S. Cl. 220/573.1

(57) ABSTRACT

A baking pan assembly which may comprise a cavity defined by a concave wall having a first side portion, a second side portion and a top portion, the concave wall having an inside surface which may have a three-dimensional design formed thereon and a bottom wall.

### RELATED APPLICATIONS

This application is a divisional of U.S. application Ser. No. 10/855,069, filed May 27, 2004.

### FIELD OF THE INVENTION

The invention relates to a novelty bun having a sculptural surface or artistic shape and to methods of manufacture thereof.

### BACKGROUND OF THE INVENTION

Conventional buns such as hot dog and hamburger buns have a simple and merely utilitarian shape; they generally feature a uniform and unornamented surface. The shape is generally controlled by the intended application; e.g. hot dog buns are oblong and hamburger rolls are round. The only ornamentation is typically sesame seeds, onion flakes, or other garnish sprinkled on the surface, or split or cut surface. The conventional baking process, which involves proofing and baking dough on a planar surface, does not allow the creation of buns which have a sculptural shape.

### SUMMARY OF THE INVENTION

One embodiment pertains to a baking apparatus for baking breads such as hamburger rolls or hot dog buns having a sculpted surface. The apparatus includes a baking pan having a cavity having a floor, a wall and a ceiling. The floor of the cavity may be recessed, or concave. The ceiling of the cavity generally extends only partially over the floor. The baking pan has a design in base relief on the floor, wall and upper portion of the cavity. The cavity also generally has a large opening for the removal of the finished product. The cavity may be configured to produce single articles of bread or clusters. The baking pan may be of any desired shape such as round, rectangular or oblong. The baking pan may be of unitary or of two-piece, or multi-piece construction. Another embodiment is a baking pan cover which may be used with a standard baking pan to produce articles of bread having a design in them.

The above summary of some embodiments is not intended to describe each disclosed embodiment or every implementation of the present invention. The figures and detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings in which:

FIG. 1 is a partial perspective view of an example baking pan assembly 100;

FIG. 2a is a rear view of baking pan assembly 100;

FIG. 2b is a partial rear view of baking pan assembly 100 in use;

FIG. 2c is a partial side view of baking pan assembly 100;

FIG. 2d is a partial side view of baking pan assembly 100 in use;

FIG. 2e is a partial top view of baking pan assembly 100;

FIG. 2f is a partial top view of baking pan assembly 100 in use;

FIG. 3a is a side view of a bun 114;

FIG. 3b is a front view of bun 114;

FIG. 3c is a top view of bun 114;

FIG. 3d is a perspective view of an article of bread 114 in a bun arrangement;

FIG. 4 is a perspective view of a baking pan assembly 300;

FIG. 5 is a perspective view of a baking pan assembly 400;

FIG. 6 is a partial perspective view of a baking pan assembly 500

FIG. 7 is a perspective view of a bun 518 in a bun arrangement;

FIG. 8a is a partial rear view of a baking pan assembly 600;

FIG. 8b is a partial rear view of baking pan assembly 600 in use;

FIG. 8c is a front view of a bun 614; and

FIG. 9 is a perspective view of a baking pan assembly 700.

### DETAILED DESCRIPTION OF ILLUSTRATIVE EMBODIMENTS

Reference is now made to the figures, in which like element numbers refer to like elements throughout.

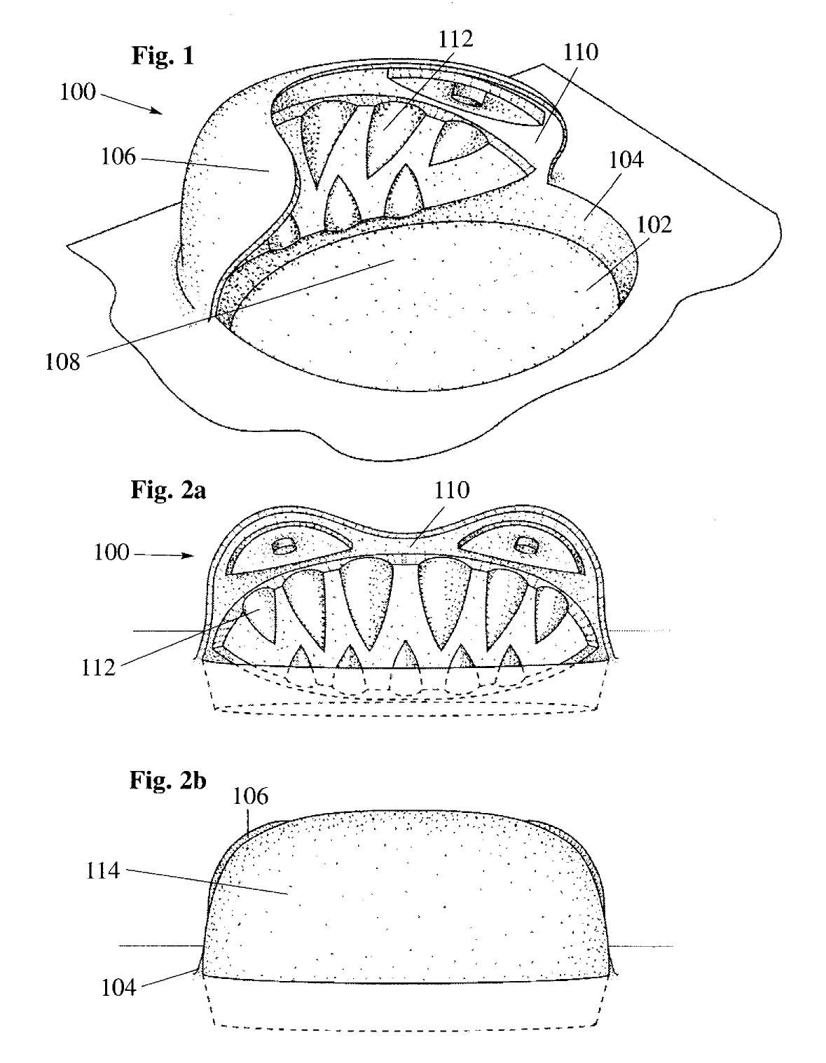

FIG. 1 is a partial perspective view of baking pan assembly 100, which includes a bottom wall 102, a side wall 104, and a top wall 106. These walls at least partially define a baking cavity 108. Side wall may extend around the perimeter of bottom wall 102, may only partially extend around the perimeter of the bottom wall, may have a base portion which extends around the perimeter of the bottom wall and a top portion which extends only partially around the perimeter of the bottom wall as in the depicted embodiment, or may have another suitable configuration. Top wall 106 may only partially extend over cavity 108 and may have less area than bottom wall 102. For example, top wall 106 may be essentially a lip. In the embodiment shown top wall 106 is essentially a lip on side wall 104. Top wall 106 may also be offset from the center of cavity 108. Top wall 106 and side wall 104 generally form a concave inner surface 110 in which a three-dimensional pattern 112 may be formed. Pattern 112 may be any desired pattern, such as the fanciful face depicted in the Figure. The extent and configuration of side wall 104 and top wall 106 may be determined in regard to the pattern desired. For example, one embodiment may be a baking pan assembly which has a side wall with a pattern, a bottom wall and no top wall.

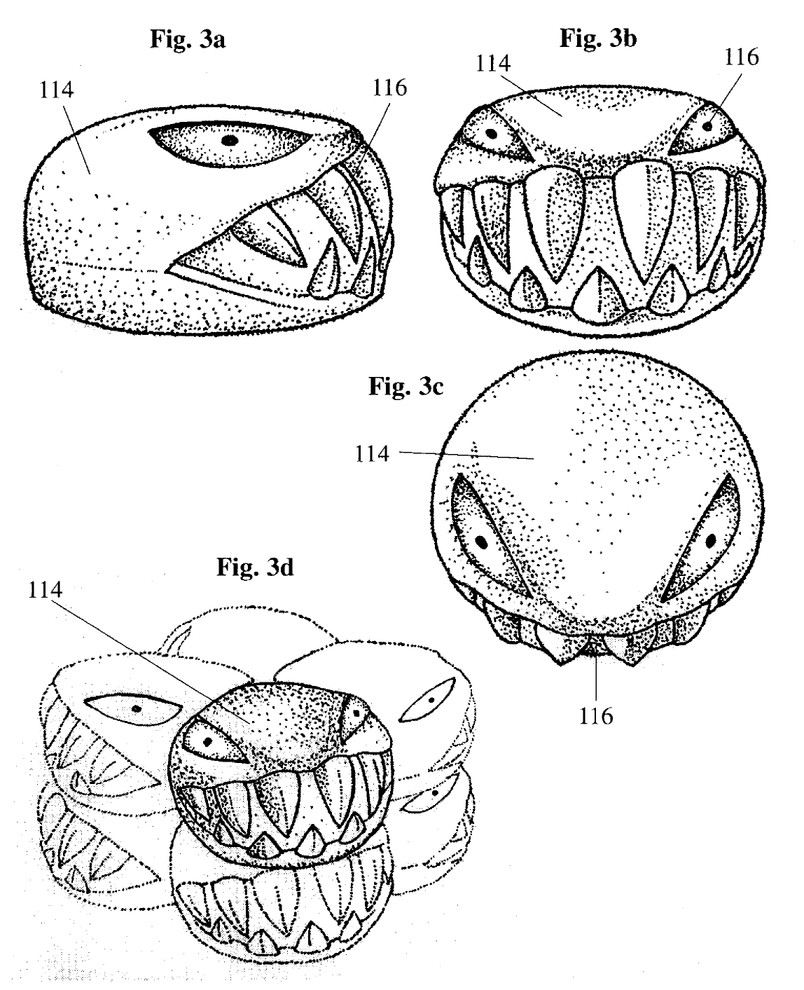

Pan 100 may include a plurality of such baking cavities 108 arranged in any suitable fashion, such as in columns and rows. Another suitable configuration is to arrange the baking cavities in a cluster fashion, having 2, 4, 8 or another desired number of cavities in close proximity with no separating wall so that the bread articles baked together, as is shown in FIG. 3d. Pan 100 may have a variety of baking cavities 108, each cavity or set of cavities having a different pattern and configuration of walls, if desired. Pan 100 may be made of any suitable material and by any suitable process. For example, baking pan 100 may be made of steel or aluminum and may be formed by a molding, stamping, welding, machining, or hydroforming process, or other suitable process or combination thereof. Pan 100 may include a coating such as an anodized coating or a non-stick coating. Pan 100 may be made of other suitable materials including polymers such as silicone, metal reinforced polymers, paper, ceramic or glass. Pan 100, as shown and described, causes variance in browning which accentuates the design. Different materials may cause the surface of the article of bread to brown differently. Thus different sections of baking pan assembly 100 may be made from different materials to achieve a product having a surface with selective shading. For example, the pan may be generally made from an aluminum having a dark coating while the teeth and the eyes in the pattern may be made from silicone. This may produce a product where the teeth and eyes on the bun are lighter than the surrounding surfaces. Selective browning may also be achieved by the use of varying thicknesses of material or by the selective application of reflective or darkening coatings to the pan.

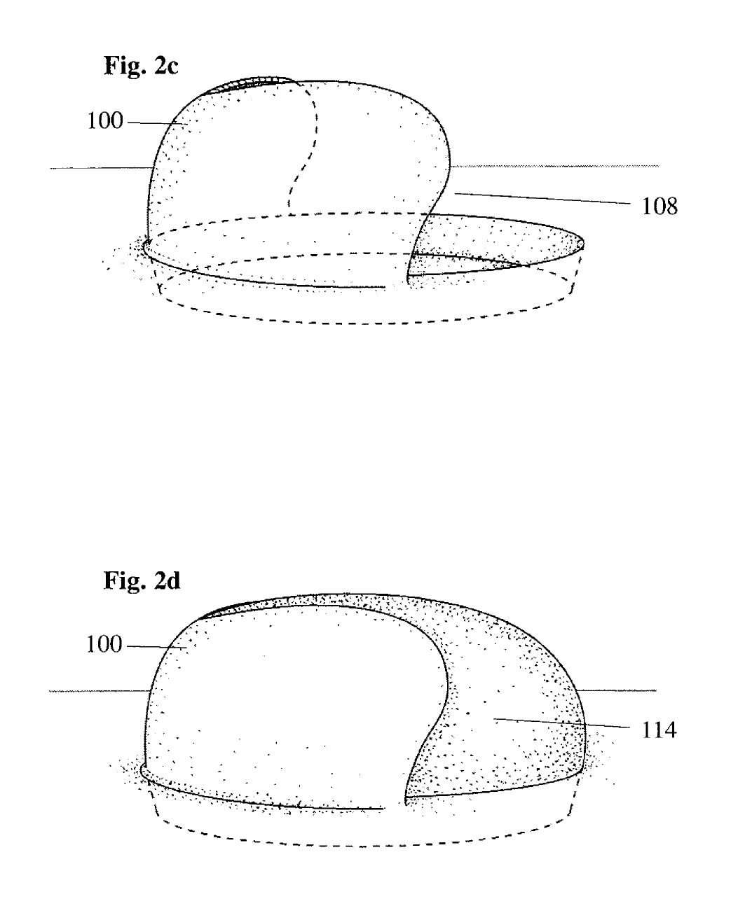

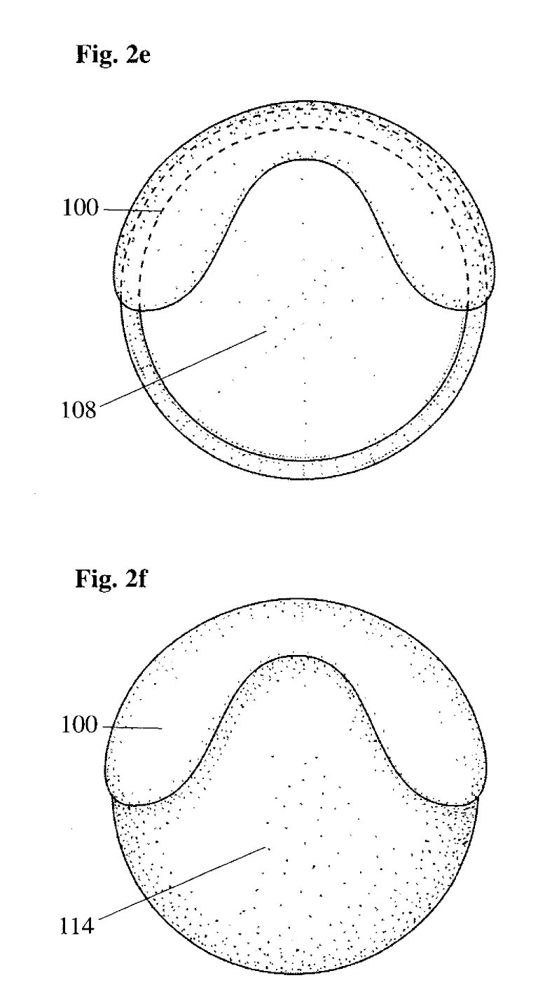

FIGS. 2a, 2c, and 2e are a rear partial view, a side partial view and a top partial view, respectively, of baking pan assembly 100. FIGS. 2b, 2d, and 2f are a rear partial view, a side partial view, and a top partial view, respectively, of baking pan assembly 100 in use. Bread article 114 is in cavity 108 and as depicted is in a proofing or baking stage. Dough is herein understood to be a precursor to a bread product such as a loaf, a bun, or a roll. Dough usually includes at least flour, water, and a leavening agent such as yeast or baking powder. Any dough which can rise and press against surface 110 may be suitable for use in the baking pan assembly.

The process of using baking pan assembly 100 generally includes putting a suitable quantity of dough in cavity 108. Dough may be shaped into a ball or disc, if desired. The dough may then be proofed for a desired period of time; the proofing process permits the dough to expand and leaven. The dough is baked into an article of bread. During the proofing or baking or both, the dough rises to press against surface 110, impressing pattern 112 into the surface of the article of bread. A substantial portion of the baking happens while the dough is pressed against surface 110. This permits the baked article of bread to retain pattern 112, in reverse, in its surface. The article of bread may be allowed to cool, in which time it may shrink away from surface 110, and then may be depanned. Of course, other steps may be included if desired. For example, baking pan assembly 100 may be greased or coated with a non-stick spray, or the article of bread may be glazed or coated with a garnish such as sesame seeds. This steps outlined in this process are suitable for use in a discrete process such as baking at home or in an industrial process, which may be continuous. Baking pan assembly 100 is not limited to the features described above and may include features which render it more suitable for either a home application or an industrial application.

FIGS. 3a, 3b, and 3c are a side view, a front view, and a top view, respectively, of an article of bread 114 produced by baking pan assembly 100. Article of bread 114 includes an ornamental three dimensional design 116 imparted to it by surface 110 and pattern 112 of the baking pan assembly. FIG. 3d is a perspective view of article of bread 114 in an ornamental arrangement displaying design 116 to good effect.

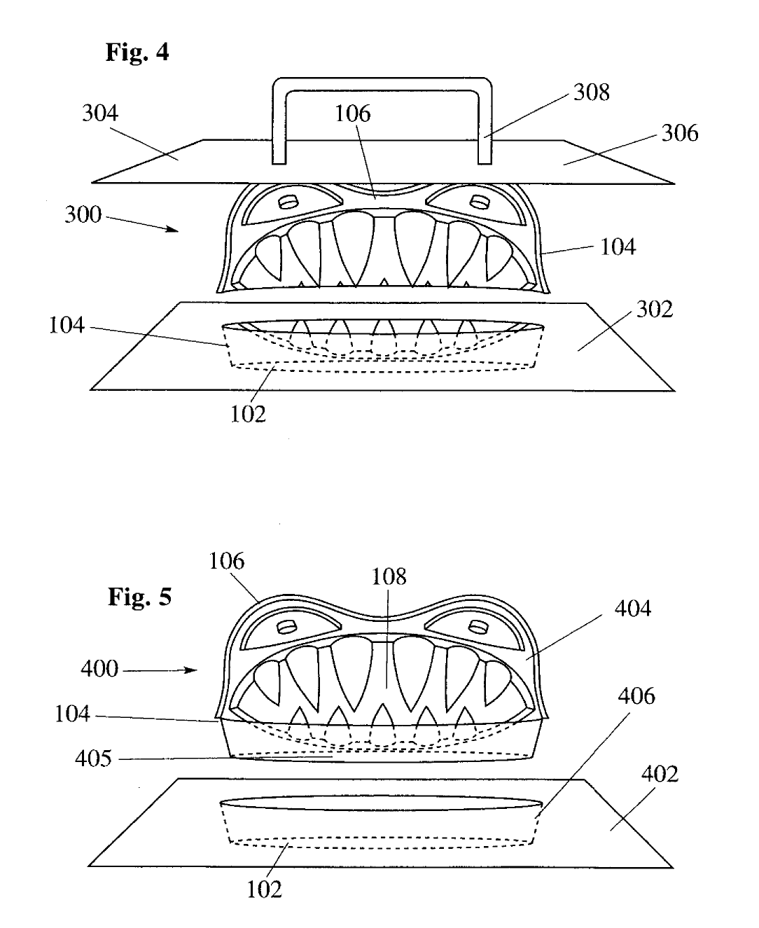

FIG. 4 is a schematic perspective view of a baking pan assembly 300, which has two-piece construction. The base pan 302 includes bottom wall 102 and may include a portion of side wall 104. The cover pan 304 includes the remainder of side wall 104 and top wall 106. Base pan 302 and cover pan 304 come together to define baking cavity 108. FIG. 4 depicts only one baking cavity, but the baking pan assembly may include multiple baking cavities arranged as desired. Cover pan 304 may include a planar member 306 to which additional side and top walls may be attached, and may include handle 308. In one alternative embodiment, planar member 306 is a lattice work grid joining a plurality of top walls 106 together. Pan 300 may include means for positioning the cover pan with respect to the base pan, such as pins. Alternatively, the cover pan and base pan may be held in position by the baking machinery. Pan 300 permits the removal of the cover pan prior to depanning of the article of bread. This may permit configurations where side walls and top walls more completely envelope cavity 108.

FIG. 5 is a perspective view of a baking pan assembly 400, which includes tray 402 and lid 404. Tray 402 includes bottom wall 102 and receiving wall 406, which is configured to receive a portion of side wall 104. Lid 404 includes side wall 104 and top wall 106 and may include a bottom wall 405. Alternatively, lid 404 may not include bottom wall 405. When the lid is inserted into the tray, baking cavity 108 is formed. Of course, baking pan assembly 400 may include other features such as a planar member 306 or handle 308 similar that of baking pan assembly 300. Tray 402 may be a standard baking tray, which lid 404 may insert into to form baking pan assembly 400.

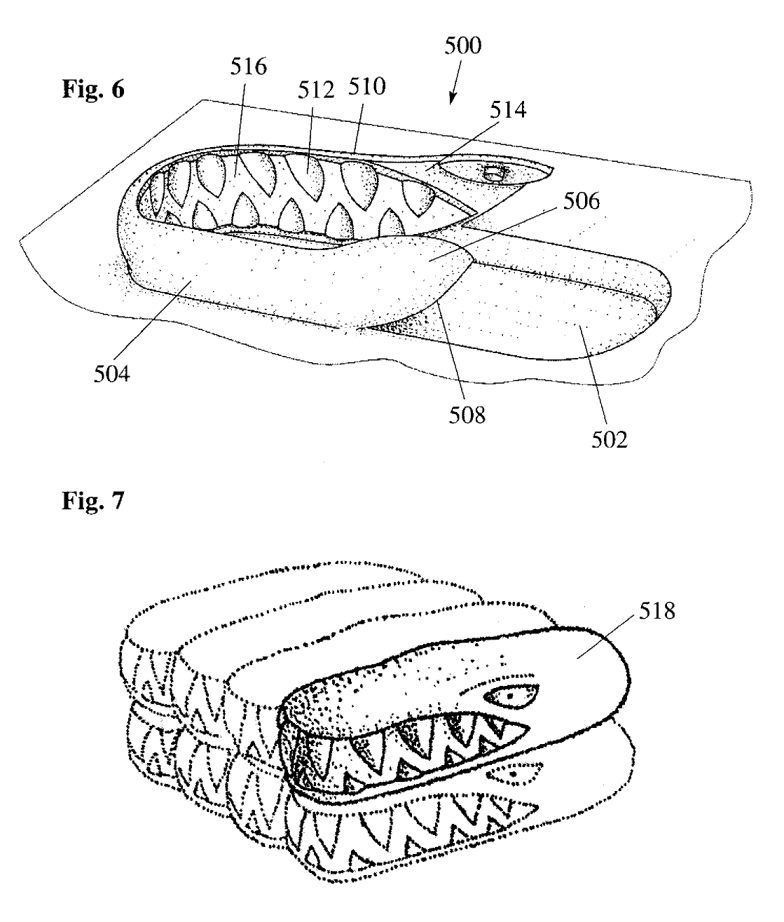

FIG. 6 is a partial perspective view of a baking pan assembly 500. Baking pan assembly 500 includes a bottom wall 502, a side wall 504 and a top wall 506. Side wall 504 includes an edge 508 having a vertical component and top wall 506 includes an edge 510. These edges may form apart of pattern 512 formed into surface 514. For example, in this embodiment edge 508 may define a cheek and edge 510 may define a lip. This may happen when and if the dough expands beyond the edges of cavity 516 during the proofing or baking process. Thus the extent of walls 504 and 506 may form a part of the ornamental pattern. A bun 518 as might be produced by baking pan assembly 500 is shown in perspective view in FIG. 7 in a group of such buns.

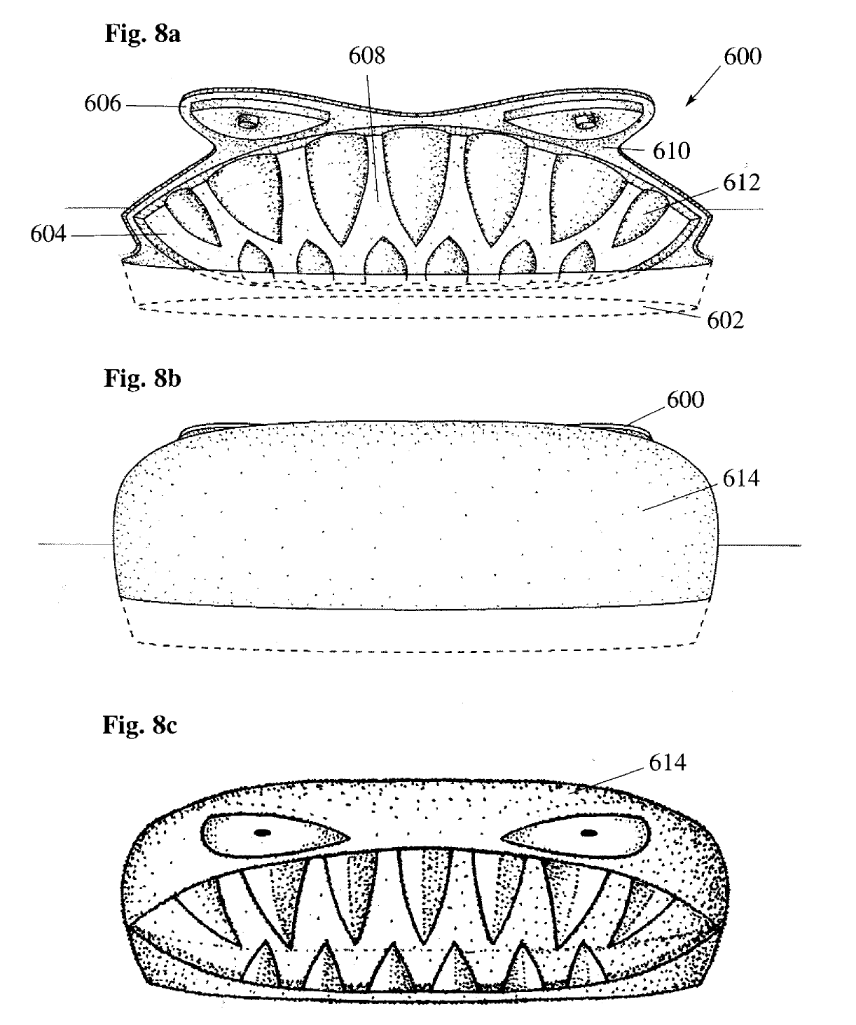

FIG. 8a is a partial rear view of a baking pan assembly 600, which has a bottom wall 602, a side wall 604 and a top wall 606 partially defining a cavity 608. A three dimensional pattern 612 is formed into an inner surface 610 that is part of walls 604 and 606. Of course, pattern 612 could extend to wall 602 if desired. FIG. 8b is a partial rear view depicting a bun 614 disposed in cavity 608 of baking pan assembly 600. FIG. 8c is a front view of bun 614 removed from the baking pan assembly.

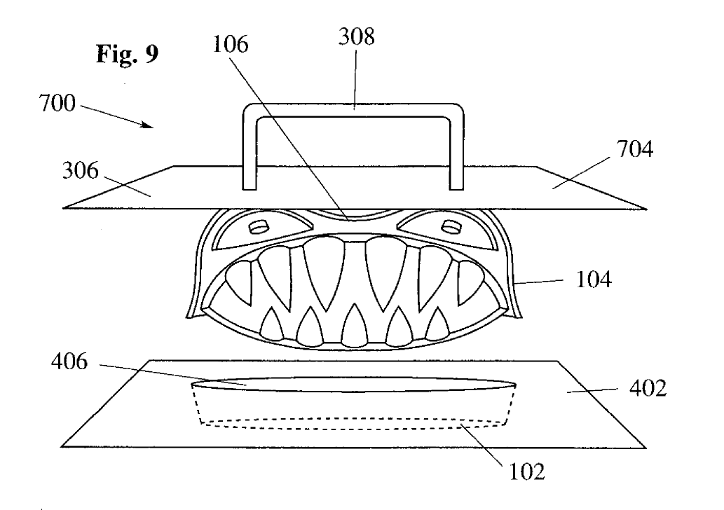

FIG. 9 is a schematic rear view of a baking pan assembly 700. Baking pan assembly 700 includes a tray 402 and a lid 704. Tray 402 includes a bottom wall 102 and a receiving wall 406. Cover 704 includes side wall 104 and may include a top wall 106. The shape and extent of side wall 104 and top wall 106 creates the ornamental design in the bread article. Cover 704 may include a planar member 306 to which additional side and tip walls may be attached, and may include a handle 308 or means for attaching cover 704 to automated baking machinery.

In another embodiment, a cover such as cover 704 or cover 404 may be configured to be used with a standard baking pan. Thus, to produce an ornamented article of bread or to change designs only a cover needs to be provided.

Numerous advantages of the invention covered by this document have been set forth in the foregoing description. It will be understood, however, that this disclosure is, in many respects, only illustrative. Changes may be made in details, particularly in matters of shape, size, and arrangement of parts without exceeding the scope of the invention. The invention's scope is, of course, defined in the language in which the appended claims are expressed.

What is claimed is:

1. A baking pan, comprising: a cavity defined by a concave wall having a first side portion, a second side portion and a top portion, the concave wall having an inside surface having a three-dimensional design formed thereon; and a bottom wall.

2. The pan of claim 1, wherein the design extends over at least part of the first side portion, the second side portion and the top portion.

3. The pan of claim 1, wherein the wall is curved laterally.

4. The pan of claim 1, wherein the wall is curved vertically.

5. The pan of claim 1, wherein the design is embossed into the surface.

6. The pan of claim 1, wherein the design is molded into the surface.

7. The pan of claim 1, wherein the design resembles a face.

8. The pan of claim 1, wherein the top portion extends over only a part of the bottom wall.

9. The pan of claim 1, wherein the pan comprises a base having the bottom wall and a lid having the concave wall.

10. The pan of claim 9, wherein the base comprises a perimeter lip disposed on the bottom wall, and wherein the lid fits into the perimeter lip.

11. The pan of claim 1, wherein the concave wall and the bottom wall are fixed to each other.

12. The pan of claim 1, further comprising a second cavity.

13. The pan of claim 1, further comprising an array of cavities.

14. A baking pan, comprising a bottom wall having a first area and a first center; a top wall having a second area less than the first area and a second center; and a side wall joining the bottom wall to the top wall and extending only partially around the top wall.

15. The pan of claim 14, wherein the first center of the top wall is laterally offset from the second center of the bottom wall.

16. The pan of claim 15, wherein the top wall is concave.

17. The pan of claim 16, wherein the top wall is concave in two directions.

18. The pan of claim 14, wherein a three-dimensional design is formed in an inner surface of the top wall and an inner surface of the side wall.

19. The pan of claim 14, wherein the side wall is laterally curved.

20. The pan of claim 14, wherein the top wall is an arced lip disposed on the side wall.

21. The pan of claim 14, wherein a central portion of the bottom wall is not covered by the top wall.

22. A baking pan comprising a bottom wall; a perimeter wall having an edge with a vertical component; and a top wall having an edge; the bottom wall, perimeter wall, and top wall partially defining a cavity.

23. The pan of claim 22, wherein the top wall is a lip on the perimeter wall.

24. The pan of claim 22, wherein the edge of the top wall and the edge of the perimeter wall form a continuous edge.

25. The pan of claim 22, further comprising a surface adjacent the cavity having a three dimensional pattern formed therein.

26. The pan of claim 25, wherein the pattern extends over the top wall and the side wall.

27. The pan of claim 22, wherein a piece of dough proofed and baked into an article of bread in the cavity of the pan will retain an impression of the edge of the top wall in a surface of the article of bread.

28. A cover for use with a baking pan, comprising: a lid having an inner surface at least partially enveloping a cavity, the inner surface having a three-dimensional design formed therein.

29. The cover of claim 28, wherein the inner surface comprises a concave portion having a side portion and a top portion.

30. The cover of claim 28, wherein the top portion extends over only a portion of the cavity.

31. The cover of claim 28, further comprising a second lid disposed laterally from the lid, the second lid having a second inner surface at least partially enveloping a second cavity, the second inner surface having a second three-dimensional design formed therein.

32. The cover of claim 31, further comprising a planar member attached to the lid and the second lid.

33. The cover of claim 31, further comprising a plurality of lids disposed laterally with respect to each other, each lid having an inner surface at least partially enveloping a separate cavity, each inner surface having a three-dimensional design formed therein.
